(19) United States
(12) Patent Application Publication
(10) Pub. No.: US 2006/0277300 A1
(43) Pub. Date: Dec. 7, 2006

(54) Ip communications network provided with direct service selection equipment

(76) Inventors: Damien Galand, Chaville (FR); Olivier Marce, Massy (FR)

Correspondence Address: SUGHRUE MION, PLLC, 2100 PENNSYLVANIA AVENUE, N.W., SUITE 800, WASHINGTON, DC, 20037, US

(21) Appl. No.: 10/564,726

(22) PCT Filed: Jun. 30, 2004
(86) PCT No.: PCT/FR04/01695

§ 371 Date: Mar. 6, 2006

(30) Foreign Application Priority Data
Jul. 18, 2003 (FR) 03/08771

(51) Int. Cl. G06F 15/173

(52) U.S. Cl. 709/225

(57) ABSTRACT

An Internet Protocol communication network (N) comprises communication equipments (Tj, Sk) certain of which offer at least one service. Certain of the equipments (Tj) comprise management means (MG) which, when they receive a coded address containing address data representing the address of a service equipment (Sk) that offers a service and belongs to a portion of the network (N) that has no service selection means and service data representing the offered service, store the received address data in a memory (M) in corresponding relationship to the service data conjointly received. Accordingly, if one of the communication equipments (Tj) wishes to access a selected service, its management means (MG) determine in its memory (M) the address data representing the address of the service equipment (Sk) that offers the selected service, in order to set up a connection therewith.

The invention concerns the field of Internet Protocol communication networks, be they of IPv4, IPv6 or mixed IPv4/IPv6 type.

In certain situations, an Internet Protocol (IP) network must be considered as “non managed”. In the present context, the expression “non managed” means there is no local expertise for managing and configuring the network. This may result from an impossible situation arising, for example, from the mobility of the communication equipments (or “hosts”) of the network or for technical reasons, in particular during the network installation phase. However, this may also result from making a selection, for example in the situation of a residential network.

In the present context, the expression “communication equipment” means any server or terminal type network equipment, for example a laptop or desktop computer, a mobile telephone or a personal digital assistant (PDA).

A non-managed network of the above kind undoubtedly provides services linked to address configuration (or “addressability”) and to routing (or “reachability”), but it provides no other services, such as those offered by a domain name server (DNS), for example.

Consequently, if a communication equipment, for example a terminal, wishes to connect to a selected service, it may be impossible to determine the address of the equipment that offers that service.

Moreover, for a non-managed network to be able to evolve, it is important to take account of its migration phases, for example from an IPv4 version to an IPv6 version, during which there exist in a transient manner nodes of mixed IPv4/IPv6 type requiring to contact IPv4 or IPv6 type equipments, for example printers. More generally, it is a question of managing the transition phases between non-managed networks that offer the possibility of determining the address of the equipments offering a given service and non-managed networks that do not offer that possibility. As taking this into account is not possible at present, certain services may be unavailable temporarily or for longer time periods.

Undoubtedly, in the situations cited above, the user who requires access to a service can supply the IP address of the network that offers that service to his communication equipment himself. This is not practical, however, in particular if the address comprises a large number of bits.

Thus an object of the invention is to solve some or all of the problems cited above.

To this end it proposes a method of managing services offered by communication equipments of an Internet Protocol communications network, enabling:

firstly, a communication equipment belonging to a non-managed network with direct service selection to identify a (service) communication equipment offering a given service, and

secondly, a communication equipment belonging to a non-managed network portion offering service selection means to identify (service) communication equipments offering a service but belonging to non-managed network portions that do not offer this service selection means.

The method is characterized in that it consists in reporting to communication equipments that are situated not only in portions of said network that have service selection means but also in those that have none, the services that are offered by the communication equipments situated in network portions that do not have service selection means.

In a particularly advantageous embodiment, service selection is offered, in a network that allows it, by integrating into the address of the communication equipments of the network that offer a service service data that represents that service (or its type and/or sub-type). Accordingly, when a communication equipment receives the address of another communication equipment offering a service, it can deduce therefrom the type of service offered. Conversely, if a communication equipment situated in a non-managed network portion having service selection means has to connect to a given service, it can deduce the address of the equipment that provides that service either directly, because the equipment is connected directly to the non-managed network portion having service selection means, or indirectly, via an equipment that is firstly connected to that network portion and to the network portion that does not have the service selection means and secondly provides a gateway function between the two networks.

To this end, the addresses of the equipments that belong to the network portion that does not have service selection means and contain the service data are stored in the communication equipments connected to a network portion that has service selection means and to a network portion that does not have service selection means.

Address data representing the address of the equipment offering a service is preferably stored in the memory of the communication equipments in corresponding relationship to the service data representing the service offered. Accordingly, the communication equipment has a kind of directory of available services and corresponding addresses.

Consequently, if a communication equipment requires to access a designated service, the address data that represents the address of the equipment offering the designated service is determined in that communication equipment, in order to send IP packets to the latter in the conventional way, at the extracted address.

The addresses including the service data are preferably supplied by broadcasting them, for example in the form of service messages.

Moreover, if two equipments offer the same service but in accordance with different network layer protocol versions, it is advantageous to select the equipment that uses one of the two versions (for example IPv6 or IPv4), and then generate and send to that equipment a packet conforming to the selected format (IPv6 or IPv4) including a header containing at least the address data representing the destination address of said selected equipment.

The invention also proposes a communication equipment (or “host”) for an Internet Protocol communication network.

The communication equipment is characterized in that it contains management means with the purpose of, when it receives address data representing an address of another equipment belonging to a portion of the network having no service selection means and offering a service and service data representing the service offered, storing the address data received in corresponding relationship to the service data received conjointly in a memory.

Each communication equipment therefore has access to a services correspondence table enabling it, when it wishes to access a designated service, easily to determine the address data that represents the address of the equipment that offers the designated service, in order to set up a connection therewith. In the case of a mixed (IPv4/IPv6) type communication equipment, the table stores the services provided by the IPv4 network portion and the services provided by the IPv6 network portion, for example.

The management means are preferably adapted, when they have determined in the memory two equipments offering the same service but in accordance with different network layer protocol versions, to select the equipment that uses one of the two versions (for example IPv6 or IPv4). They can then generate and send to the selected equipment a packet conforming to the selected format (IPv6 or IPV4), including a header containing at least the address data representing the destination address of the selected equipment, in order to set up a connection therewith.

A communication equipment of the above kind can be a server or a communication terminal, for example.

The invention relates further to a (service) communication equipment for an Internet Protocol communication network that offers at least one service and comprises sending means for broadcasting to communication equipments in the network messages including address data representing its address and service data representing the service that it offers.

In an advantageous embodiment, the sending means are adapted to place the address data and the service data in the address field of the IP data packet header.

For example, in the case of IPv6 service equipments, the sending means may be adapted to place the address data and the service data in the last 64 bits of the IPv6 address field, the first 64 bits being dedicated to identification of the network and to the route for contacting the equipment whose address is defined in the last 64 bits. In this case, a first portion of the service data may be dedicated to a type of service and coded in six of the last 64 bits and a second portion of the service data may be dedicated to a sub-type of said service type and coded with the address data in the remaining 58 bits of the last 64 bits.

The invention is particularly well adapted to communication equipments that either offer services or do not offer services and that use the network layer protocol versions IPv4 and IPv6 and/or IPv4/IPv6.

Other features and advantages of the invention will become apparent on reading the following detailed description and examining the appended drawings, in which:

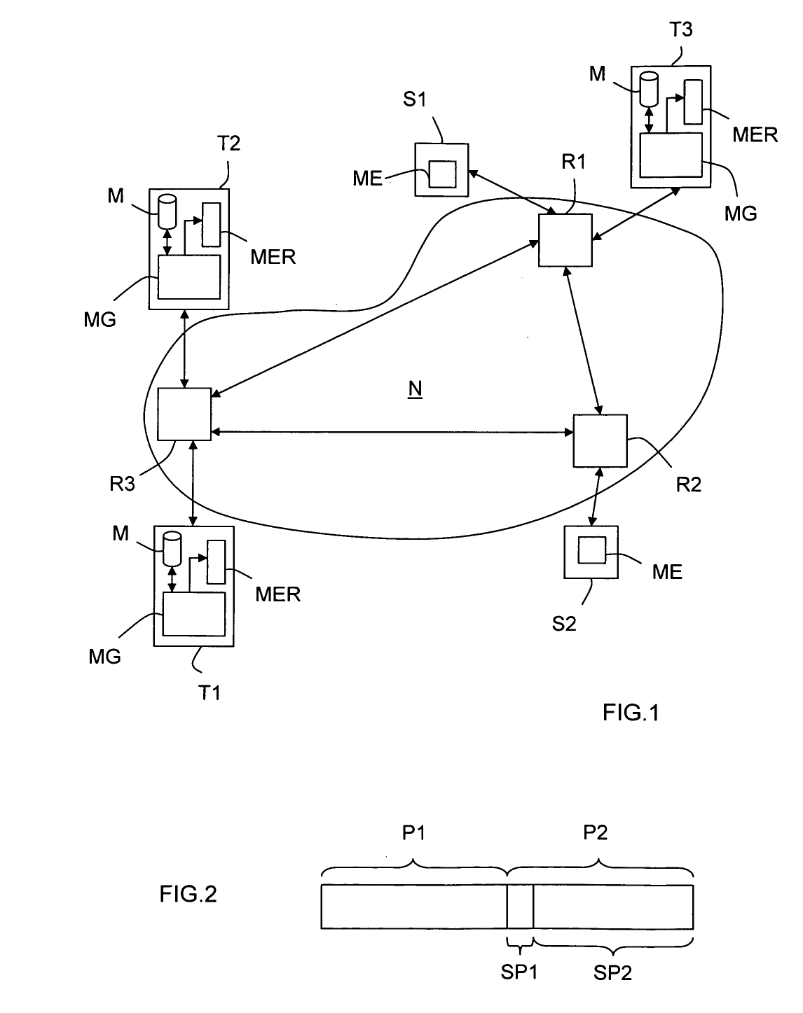

FIG. 1 is a diagram of a mixed IPv4/IPv6 Internet Protocol network including communication equipments according to the invention offering no services and communication equipments according to the invention offering services, and

FIG. 2 is a diagram of one example of the composition of an IPv6 address field in accordance with the invention.

The appended drawings constitute part of the description of the invention as well as contributing to the definition of the invention, if necessary.

An object of the invention is to enable direct service selection within an Internet Protocol (IP) communications network of the IPv4, IPv6 or the mixed IPv4/IPv6 type.

In the present context the expression “mixed type network” refers to a network comprising, firstly, communication equipments using only the IPv4 or IPv6 network layer protocol version and, secondly, mixed communication equipments, so called because they use both the IPv4 and IPv6 network layer protocol versions.

Moreover, in the present context, the expression “communication equipment” refers to any server or terminal type network equipment, for example a laptop or desktop computer, a mobile telephone, or a personal digital assistant (PDA).

It is considered hereinafter that the IP network is of the mixed type.

As shown in FIG. 1, an Internet Protocol network N of the mixed IPv4/IPv6 type may be treated, very broadly speaking, as a set of nodes, such as edge routers or core routers Ri (here i=1 to 3, but may take any value greater than or equal to 1), that are interconnected in order to route data packets that they receive, and a set of communication equipments, such as terminals Tj and Sk (here j=1 to 3, but may take any value greater than or equal to 2, and k=1 or 2, but may take any value greater than or equal to 1), connected to certain routers Ri, where applicable via one or more other access server type terminals, in order to exchange data packets.

The communication equipments Tj and Sk are of the mixed (IPv4 and IPv6) type, or of the simple (IPv4 or IPv6) type. Certain communication equipments, referred to hereinafter as service equipments Sk, also offer one or more services. Hereinafter, a communication equipment that does not offer services is designated Tj.

A service may belong to a type (or class) or to a sub-type (or sub-class) of a given type. For example, a service type may combine service equipments (for example printers) capable of printing documents, and that type may be subdivided into at least a first sub-type comprising service equipments Sk (i.e. printers) capable of printing documents in black and white and a second sub-type combining service equipments Sk (i.e. printers) capable of printing documents in color.

An IP network N generally includes non-managed network portions which may or may not be equipped with service selection means such as a DNS. Consequently, certain communication equipments Tj, which belong to a non-managed network portion that does not offer such service selection means, cannot be connected to service equipments Sk.

To solve this problem, the invention proposes to report which services are offered by the service equipments Sk that are situated in the network portions that have no service selection means to the communication equipments Tj that are situated not only in the network portions that have service selection means but also in those that do not have them.

To this end, there may advantageously be integrated into the addresses of the service equipments Sk service data representing the services that they offer (or types and/or sub-types of services).

There are generated in this way “coded” addresses that are supplied to at least certain of the communication equipments Tj, and in particular to those of mixed type, which store them in a memory M.

The mixed type communication equipments Tj can communicate not only with service equipments Sk of IPv4 type but also with those of IPv6 type, which means that they can access a greater number of service equipments Sk. However, the coded addresses could equally be supplied to the communication equipments Tj of non-mixed type. Devices are available for converting from the IPv4 format to the IPv6 format and vice versa.

It is considered hereinafter, by way of illustrative example, that all the communication equipments Tj are of the mixed type.

The service data constitutes the identifier of a type of service and/or the identifier of a service sub-type, for example. In the case of a service sub-type, it is advantageous, as explained hereinafter, for a first portion of the service data to constitute a type identifier and a second portion of the service data to constitute a sub-type identifier.

In other words, a coded address comprises address data supplying the IP address of a service equipment Sk offering a service and service data supplying the identifier of the type of service offered and/or the identifier of each service sub-type offered.

Each communication equipment Tj includes a management module MG connected to the memory M which, when it is supplied with coded addresses (address data and service data) stores it in said memory M.

The service data is preferably stored by the management module PM in the form of a table of the correspondences between the IP addresses of the service equipments Sk that offer a service and the service type (and/or sub-type) identifiers. For example, in the case of communication equipments Tj of mixed type, the correspondence table may be divided into two portions, one concerning the services offered by service equipments Sk of the IPv4 type and the other concerning services offered by service equipments Sk of the IPv6 type.

Once it has access to the address data and service data of the service equipments Sk of the network N, a communication equipment Tj may then ensure that direct service selection is invoked. Direct service selection consists, in the event of a request for access to a selected service, in determining the address of the service equipment Sk that offers that service, without recourse to a third party equipment, such as a DNS.

According to the invention, each management module MG determines in the memory M to which it is connected the address data that represents the IP address of the service equipment Sk offering the service that is designated by its type (or sub-type) identifier in the request. Once this has been determined, the management module MG knows the IP address of the service equipment Sk and can communicate it to the send/receive module MER of its communication equipment Tj in order for it to set up a connection with that service equipment Sk in a completely standard manner (i.e. by generating an IPv4 or IPv6 packet, according to the version used by the service equipment Sk that has been determined, and including in the address field of its header the IPv4 or IPv6 address of said service equipment Sk, as determined in the memory M).

Of course, if the service equipment Sk that has been determined supports address coding, the coded address (address data and service data) is placed in the address field of the header of the packet that is sent to it.

If determining the IP address in a memory M leads to several options, the management module MG must make a choice. For example, the management module MG may be configured to select with the highest priority a service equipment Sk that uses the IPv6 version. However, giving priority to selecting a service equipment Sk′ that uses the IPv4 version could equally be envisaged. Selection based on a particular sub-type when the request designates only a type divided into sub-types may also be envisaged. For example, if printing is requested, priority may be given to selecting a service equipment Sk providing color printing. The coded addresses may be supplied to the communication equipments Tj either by a person or by the network.

In the former situation, it is the person who loads into the communication equipment Tj a file of coded addresses stored on a medium such as a 3.5″ diskette, a magneto-optical disk or a CD-ROM.

In the latter situation, two situations may be envisaged.

In a first situation, a person is responsible for connecting the mixed communication equipment Tj to a server (or to an Internet site) in order to download the coded address file that it contains and thereby to update the memory M of the mixed communication equipment Tj.

In a second situation, which at present is preferred, the service equipments Sk are themselves responsible for broadcasting their coded address at least to the mixed communication equipments Tj. The service equipments Sk comprise for this purpose a sender module ME for broadcasting their addresses, for example in the form of service messages each including address data and service data.

If the coded addresses are broadcast in the form of messages, it is particularly advantageous for each message to constitute an IP data packet, preferably to the IPv6 format. However, the coded address may equally be sent in the form of a message constituting an IPv4 packet, of course.

It is more preferable if the sender module ME uses the address field in the header of an IP packet to “code” the address data and at least a portion of the service data.

For example, in the case of the IPv6 protocol, the field reserved for the IP address of a communication equipment in the header of an IP packet consists of 128 bits. This field is divided into two portions P1 and P2 each of 64 bits. The first portion P1 is conventionally dedicated to network identification and to identifying the route for contacting the service equipment Sk whose address is defined in the second portion P2.

Only part of this second portion P2 of 64 bits being used, the invention proposes to use it to code the address data and at least a portion of the service data. Coding may be effected in at least two ways.

A first way is to adapt the sender module ME of each service equipment Sk to generate a code of 64 bits representing both its IP address and its type (and/or sub-type) identifier.

A second way, currently preferred and shown in FIG. 2, is to adapt the sender module ME of each service equipment Sk to subdivide the second portion P2 which follows the first portion P1 into two sub-portions SP1 and SP2.

The first sub-portion SP1 is dedicated to the type identifier, for example, while the second sub-portion SP2 is dedicated both to the sub-type identifier (if any) and to the IP address of the service equipment Sk. In other words, the first sub-portion SP1 comprises a first portion or all of the service data and the second sub-portion SP2 comprises a second portion of the service data and the address data. It is important to note that the address data and the second portion of the service data may be lumped together in a code constituting the second sub-portion SP2.

When coding is provided, the sender module ME of each service equipment Sk executes a coding algorithm that is fed with identifiers and addresses and delivers codes.

For example, the first sub-portion SP1 may comprise six bits each consisting of an alphanumeric character chosen from nine characters (preferably identical to those used by the DNSs) or the underscore symbol “_”. The second sub-portion SP2 then consists of 58 bits each consisting, for example, of a character selected from 36 characters (ordinates from “a” (N° 0) to “z” (N° 25), then from “0” (N° 26) to “9” (N° 35), and finally “_ (N° 36)).

Other types of coding may be envisaged, of course.

It is important to note that in the presence of address fields containing second portions P2 containing codes, the management module MG of each communication equipment Tj is adapted to decode said second portions P2 in order to deduce the identifiers and addresses therefrom. It can then store the identifiers and addresses in the correspondence table of the memory M. This way of transmitting coded addresses via the IP address field is particularly advantageous because it avoids using a specific protocol, for example SLP, dedicated to the service information search.

The management modules MG and memories M of the communication equipments Tj of the invention and the sender module ME of each service equipment Sk of the invention may take the form of electronic circuits, software (or electronic data processing) modules, or a combination of circuits and software.

The invention also offers a method dedicated to managing services offered by communication equipments Sk of an Internet Protocol communication network.

This may in particular be effected through the use of the communication equipments Tj and/or service equipments Sk described above. The main and optional functions and sub-functions of the steps of that method being substantially identical to those of the various means constituting the communication equipments Tj and/or the service equipments Sk, only the steps implementing the main functions of the method of the invention are summarized hereinafter.

That method consists in reporting to the communication equipments Tj that are situated not only in the network portions that have service selection means but also in those that have no such means, the services that are offered by the service equipments Sk that are situated in the network portions that have no service selection means.

In a particularly advantageous embodiment, service selection is offered by integrating into the address of a service equipment Sk the network service data that represents that service (or its type and/or sub-type).

The addresses coded in this way are preferably stored in the communication equipments Tj, for example in the form of a table of the correspondences between address data representing the address of the service equipment Sk offering a service and service data representing the service offered.

If a communication equipment Tj wishes to access a designated service, it can then determine in that equipment Tj the address data that represents the address of the service equipment Sk offering the designated service in order to set up a connection therewith.

These coded addresses are preferably broadcast via the network N, for example in the form of service messages.

The invention is not limited to the communication equipment, service equipment and management method embodiments described above by way of example only, but encompasses all variants that the person skilled in the art might envisage that fall within the scope of the following claims.

1. Method of managing services offered by communication equipments (Sk) of an Internet Protocol communication network (N), characterized in that it consists in reporting to communication equipments (Tk) that are situated in portions of said network (N) that have service selection means and in portions of said network (N) that have no service selection means services offered by the communication equipments (Sk) that belong to said network portions (N) that do not have service selection means.

2. Method according to claim 1, characterized in that service data representing that service is integrated into the address of said communication equipments (Sk) offering a service.

3. Method according to claim 2, characterized in that said addresses containing the service data are stored at least in said communication equipments (Tj) using said network layer protocol versions.

4. Method according to claim 3, characterized in that said addresses containing address data representing addresses of equipments that offer a service (Sk) and service data representing the service offered and said address data is stored in corresponding relationship to said service data.

5. Method according to claim 3, characterized in that, if one of said communication equipments (Tj) wishes to access a selected service, the address data representing the address of the equipment (Sk) offering said selected service is determined in that communication equipment (Tj) in order to set up a connection therewith.

6. Method according to claim 1, characterized in that said addresses containing said address data and said service data are broadcast in said network.

7. Method according to claim 6, characterized in that said addresses are broadcast in service messages.

8. Method according to claim 1, characterized in that in the presence of two equipments (Sk, Sk′) offering the same service in accordance with different network layer protocol versions, one of the two equipments (Sk) is selected as a function if its protocol version, after which a packet is generated and sent to said selected equipment (Sk) in the format of the selected version having a header containing at least the address data representing the destination address of the selected equipment (Sk).

9. Communication equipment (Tj) for an Internet Protocol communication network, characterized in that it comprises management means (MG) adapted, firstly, in the event of receiving address data representing an address of another equipment (Sk) belonging to a portion of said network (N) that has no service selection means and offers a service and service data representing said offered service, to store said received address data in a memory (M) in corresponding relationship to said service data received conjointly, and, secondly, in the event of a request to access a selected service, to determine in said memory (M) the address data representing the address of the equipment (Sk) that offers said designated service, in order to set up a connection therewith.

10. Equipment according to claim 9, characterized in that said management means (MG) are adapted, in the event of determination in said memory (M) of two equipments (Sk, Sk′) offering the same service in accordance with different network layer protocol versions, to select one of the two equipments (Sk) as a function of its protocol version and then to generate and send to said selected equipment (Sk) a packet with the format of the selected version and containing a header containing at least said address data representing the destination address of the selected equipment (Sk) in order to set up said connection therewith.

11. Equipment according to claim 9, characterized in that it is selected from a group comprising at least servers and communication terminals (Tj).

12. Service equipment (Sk) offering at least one service and belonging to a portion of an Internet Protocol communication network (N) that has no service selection means, characterized in that it comprises sender means (ME) adapted to broadcast messages containing address data representing their own address and service data representing said service offered in said network (N) to communication equipments (Tj) according to claim 9.

13. Equipment according to claim 12, characterized in that said sender means (ME) are adapted to place said address data and said service data in the address field of the data packet header.

14. Equipment according to claim 13, characterized in that in the presence of an IPv6 type protocol format, said sender means (ME) are adapted to place said address data and said service data in the last 64 bits of the 128 bits of the IPv6 format address field, the first 64 bits of said 128 bits being dedicated to identifying the network portion and to the route for contacting said service equipment (Sk) whose address is defined in the last 64 bits.

15. Equipment according to claim 14, characterized in that said sender means (ME) are adapted to place a first portion of the service data in six of said last 64 bits and a second portion of said service data and said address data in the remaining 58 bits of said last 64 bits, said first portion being dedicated to a type of service and said second portion being dedicated to a sub-type of said type of service.

16. Internet Protocol communication network, characterized in that it comprises communication equipments (Tj) and service equipments (Sk) according to claim 9.
